(19) United States
(12) Patent Application Publication
(10) Pub. No.: US 2022/0002947 A1
(43) Pub. Date: Jan. 6, 2022

(54) BOOK PRINTING PAPER

(71) Applicant: Stora Enso OYJ, Helsinki (FI)

(72) Inventors: Juhani Hyytiäinen, Kotka (FI); Raino Kauppinen, Lappeenranta (FI); Antti Outinen, Kotka (FI)

(73) Assignee: Stora Enso OYJ, Helsinki (FI)

(21) Appl. No.: 17/291,360

(22) PCT Filed: Oct. 30, 2019
(86) PCT No.: PCT/IB2019/059284

§ 371 Date: May 5, 2021

(51) Int. Cl. D21H 19/54; D21H 19/58; D21H 19/64; D21H 19/84; D21H 23/24; B41M 5/50

(52) U.S. Cl. CPC D21H 19/54; D21H 19/58; B41M 5/502; D21H 19/84; D21H 23/24; D21H 19/64

(57) ABSTRACT

The present invention provides a book paper suitable for both inkjet and offset printing. The inventive printing paper comprises a base substrate with a grammage of below 100 gsm comprising at least 50 wt % mechanical cellulosic pulp fibers and having a total filler content of below 15 wt %. The substrate is surface treated with a composition comprising pigments in a range of 15-30 wt %, starch in a range of 20-40 wt %, latex in a range of 10-20 wt % and a multivalent metal salt in a range of 10-30 wt %.

### TECHNICAL FIELD

The present invention relates to a printing paper suitable for both inkjet and offset printing.

### BACKGROUND OF THE INVENTION

Paper, board and other fibre-based webs are often surface sized, pigmented or mineral coated on both sides to improve characteristics of the paper that affects the visual performance or printability, such as the surface porosity, the absorptivity, the wettability, or the surface energy (the ink adhesion) of the paper. Today, the printability of paper is often optimized by the addition of functional additives to the surface-size, pigmentation recipe or through the coating formulation.

New printing techniques, such as high-speed ink jet printing, puts high demands on the printing paper, since the ink must be quickly immobilized, dried and fixed on the substrate and yet provide a high print quality. A desired quality involves a high optical print density, minimized feathering and bleeding and low strike-through. In recent years, it has been found that when multivalent metal salts, such as calcium chloride, are added to the surface size, the applied ink and especially water based inks comprising pigment based colorants will precipitate fast on the surface of the paper and give rise to a significant improvement in print quality. This is especially advantageous in high speed ink jet printing using water based inks with anionic particles as colorants. U.S. Pat. No. 6,207,258 discloses a composition useful for surface treating a sheet substrate for ink jet printing, the composition comprising a salt of a divalent metal.

EP2640894 discloses a paper for digital printing which is surface treated with a composition comprising a macromolecular material, an inorganic pigment and a metallic salt.

The concepts related to the use of metal salts in surface size to improve printability known in the art are usually optimized for the use in connection with inkjet printing. In offset printing however, the use of the prior art concepts have induced problems with dusting and bad print quality. These problems are particularly connected to book paper qualities, having quite low grammage, high bulk and a large amount of mechanical pulp.

There thus remains a need to provide a paper suitable to be used as book paper, which paper provides good printing quality when printed with both inkjet and offset printing techniques.

### SUMMARY OF THE INVENTION

According to a first aspect of the invention, there is provided a paper suitable for inkjet and offset printing, said paper comprising;
a base substrate having a first and a second surface and a grammage of below 100 gsm, which substrate comprises at least 50 wt % mechanical cellulosic pulp fibers and has a total filler content of below 15 wt %, all percentages calculated on the total amount of solids of said substrate,
a surface treatment composition applied on at least the first surface of said substrate which composition comprises pigments in a range of 15-30 wt %, starch in a range of 20-40 wt %, preferably 30-40 wt %, latex in a range of 10-20 wt % and a multivalent metal salt in a range of 10-30 wt %, all percentages calculated on the total solid contents of said surface treatment composition,
and wherein the paper has a bulk of at least 1.3 cc/g.

It has been shown that the combination of said features gives rise to a paper that gives good printing properties when printed with both inkjet- and offset printing technologies without the problems with dusting connected with the prior art solutions.

The invention enables a low amount of surface treatment suspension to be applied onto the paperboard and yet provide satisfactory printing properties in both inkjet and offset printing. The high mechanical pulp content of the base paper and the low amount of surface treatment composition in turn enables the production of a paper with high bulk. This makes the paper particularly suitable to be used as book paper. The surface treatment composition is preferably applied on the first surface of the substrate in an amount of less than 2 gsm. The surface treatment composition is preferably also added on the second surface of the substrate in an amount of less than 2 gsm.

The paper of the invention may exhibit a Bentsen roughness of below 1100 ml/min. It has surprisingly been shown that such a low roughness can be achieved even when a low amount of the surface treatment composition is applied on the surface.

The multivalent metal salt is preferably chosen from the group consisting of calcium chloride, poly-aluminium chloride (PAC), magnesium chloride, magnesium bromide, calcium bromide, barium chloride, calcium nitrate, magnesium sulphate, magnesium nitrate, barium nitrate, calcium acetate, magnesium acetate or barium acetate or a mixture of these. In one preferred embodiment, the salt is calcium chloride.

The pigment used in the composition is preferably a round-like pigment. Preferably, the pigment is calcium carbonate or titanium dioxide, most preferably round-like calcium carbonate or titanium dioxide. Such round-like pigments improves the ink-setting even further. In one embodiment, the composition does not comprise any plate-like pigments like e.g. clay.

The starch may be anionic, cationic, amphoteric or non-ionic starch. In one preferred embodiment, the starch is non-ionic, amphoteric or anionic starch, most preferably non-ionic starch. Most preferably, the starch is non-ionic starch whereby undesired agglomeration with the salt can be avoided.

In a second aspect, there is provided a method of manufacturing a paper with a bulk of at least 1.3 cc/g and which is suitable for both inkjet and offset printing, said method comprising the steps of;
providing a base substrate having a first and a second surface with a grammage of below 100 gsm, comprising at least 50 wt % mechanical cellulosic pulp fibers and a total filler content of below 15 wt %, all percentages calculated on the total amount of solids of said substrate,
applying a surface treatment composition on at least the first surface of said substrate which composition comprises pigments in a range of 15-30 wt %, starch in a range of 20-40 wt %, preferably 30-40 wt %, latex in a range of 10-20 wt % and a multivalent metal salt in a range of 10-30 wt %, all percentages calculated on the total solid contents of said surface treatment composition,
and wherein the paper has a bulk of at least 1.3 cc/g.

The surface treatment composition is preferably applied onto the base substrate by use of film coating, which enables a low amount of the surface treatment composition to be applied on the surface of the substrate.

The second aspect of the invention may be further characterized by the same features as the first aspect.

### DETAILED DESCRIPTION

The present invention provides a paper suitable for both inkjet and offset printing. In accordance with the invention, a base substrate is provided with a surface treatment composition comprising pigments, starch, latex and multivalent metal salt.

The base substrate has a grammage of below 100 gsm, preferably between 55-90 gsm, comprises at least 50 wt %, preferably at least 70 wt % or at least 80 wt % of mechanical cellulosic pulp fibers and a total filler content of below 15 wt %, or below 10 wt % (calculated on the total amount of solids of said substrate). The fillers may be e.g. inorganic fillers such as clay, talc, silica and/or calcium carbonate. In addition to mechanical pulp, the substrate may also comprise chemical cellulosic pulp fibers. It may further comprise recycled pulp, deinked pulp, coated or uncoated broke or mixture of various pulps. The cellulosic pulp fibers may be hardwood and/or softwood fibers. The substrate may further comprise further additives well known in the art for papermaking such as dyes, optical brightening agents, wet strength chemicals, strength chemicals, fixatives, biocides sizing agents, drainage and retention agent etc. In one embodiment, the base substrate comprises a total amount of internal sizing agents of less than 500 g/ton. Such low amount of internal sizing agents ensures that the water applied with the aq. surface treatment suspension is absorbed in the paper and does not interfere with the print quality.

The surface treatment composition comprises pigments in an amount of 15-30 wt %, preferably 20-30 wt %, starch in an amount of 20-40 wt %, preferably 30-40 wt %, latex in a range of 10-20 wt % and multivalent metal salt in a range of 10-30 wt %, preferably 15-25 wt %, all percentages calculated on the total solid contents of said surface treatment composition. The latex could be e.g. Styrene-Acrylate latex (SA latex) or Styrene-Butadiene latex (SB latex), preferably SB latex. The surface treatment could comprise further additives, such as 0-10 wt % or 0-5 wt % additives including but not limited to cross linkers, hardeners and dispersing agents.

The paper produced in accordance with the invention is preferably made by applying a pulp comprising cellulosic fibers and optionally additives onto a wire forming a web followed by dewatering and/or drying said web in a number of steps. The surface treatment suspension may be applied onto one or both of the surfaces of the paper web on-line or off-line the papermaking machine. The surface treatment suspension is preferably applied onto one or both of the surfaces of the paper web by use of any well-known coating methods, such as blade coating, film coating, curtain coating, spray coating etc. Preferably, film coating technologies is used. The surface treatment suspension may be applied on one or both sides of the paper in an amount of less than 2 gsm, or less than 1.7 gsm or even less than 1.5 gsm. The surface suspension is preferably applied at a consistency of 2-50 wt %, more preferably 7-20 wt %.

The bulk is defined as the thickness (ISO 534) divided with the grammage (ISO 536). The bulk of the paper according to the invention is at least 1.3 cc/g, or preferably at least 1.5 cc/g or 1.7 cc/g.

The Bendsten roughness as used in the claims and throughout the description is measured in accordance with ISO 8791-2.

### Example

A trial was performed to evaluate the printing properties of the paper of the invention.

As a base substrate, an uncoated paper with a grammage of 70 gsm, comprising 87 wt % of mechanical pulp, 10 wt % of chemical pulp and 3 wt % fillers were used. A surface treatment composition was prepared in accordance with table 1, “surface treatment composition 1”.

TABLE 1

| | Surface treatment | |
|---|---|---|
| | composition 1 | |
| Raw material | [6% dry weight] | REF |
| SB Latex | 16.0% | 13.0% |
| Starch | 39.5% | 12.5% |
| Calcium carbonate | 24.0% | 74.0% |
| Calcium chloride | 20.0% | 0.0% |
| Dispersing agent | 0.5% | 0.5% |
| and hardener | | |

The base substrate was coated with said surface treatment composition in an amount of 2 gsm/side by use of film coating.

As a reference, the same base substrate was coated by coating color containing starch, latex, calcium carbonate, dispersant agent and hardener, “REF” in table 1. Application amount was 2 gsm/side by use of film coating.

Samples of the surface treated substrate of the invention and samples of the reference were printed by Albert Frankenthal A 101 S HSWO press and Sunmag HV ink serie at KCL and Kodak Prosper S10 4 color inkjet engine by using Prosper S-serie pigment inks. Speed was 50 m/min, droplet size 12.3 pl and resolution 600×600 dpi. The dusting tendency of the offset printed paper and the print quality of both the offset and inkjet printed samples of the invention (offset printed paper A and inkjet printed paper B) as well as that of the reference samples (offset paper ref. and inkjet paper ref.) were evaluated. The results and test methods can be seen in table 2.

TABLE 2

| | Offset | Offset | Inkjet | Inkjet |
|---|---|---|---|---|
| | printed* | printed* | printed | printed |
| | Ref. | Paper A | Ref. | paper B |
| Dusting tendency in | 17.6 | 12.6 | Not | Not |
| offset printing after | | | evaluated | evaluated |
| 15000 printed copies | | | | |
| in the 1^{st} unit(black), | | | | |
| summary of ink and | | | | |
| water areas | | | | |
| (ts + bs), [g/m²] | | | | |
| Mottling Cyan 50% | 5.7 | 5.6 | 4.6 | 4.6 |
| Print density | NA | NA | 1.2 | 1.7 |
| [K100] | | | | |
| Bleeding sharpness, | NA | NA | 0.78 | 0.38 |
| [mm²] | | | | |
| Bulk [cm³/g] | 1.8 | 1.8 | 1.8 | 1.8 |
| Bendtsen roughness | 320 | 390 | 320 | 390 |
| [ml/min] | | | | |
| Caliper [mm] | 128 | 128 | 128 | 128 |

*15 000 copies printed

The print mottling was measured by use Pap Eye mottling measurement at KCL. The print density was measured by ISO 13655M1. The roughness was measured by using ISO 8791-1.

As can be seen in table 2, the inventive concept gives rise to a paper that gives excellent print qualities when printed with inkjet printing and offset as well as low dusting tendency in offset heat set printing.

1. A paper suitable for inkjet and offset printing, said paper comprising:
a base substrate having a first and a second surface and a grammage of below 100 gsm, wherein said base substrate comprises at least 50 wt % mechanical cellulosic pulp fibers and a has total filler content of below 15 wt %, all percentages calculated on a total amount of solids of said base substrate, and
a surface treatment composition applied on at least the first surface of said base substrate, wherein said surface treatment composition comprises pigments in a range of 15-30 wt %, starch in a range of 20-40 wt %, latex in a range of 10-20 wt %, and a multivalent metal salt in a range of 10-30 wt %, all percentages calculated on a total solid contents of said surface treatment composition,
and wherein the paper has a bulk of at least 1.3 cc/g.

2. A paper according to claim 1, wherein the surface treatment composition is applied on the first surface of the substrate in an amount of less than 2 gsm.

3. A paper according to claim 2, wherein the surface treatment composition is applied on the second surface in an amount of less than 2 gsm.

4. A paper according to claim 2, wherein the Bendtsen roughness of the paper is below 1100 ml/min (ISO 8791-2).

5. A paper according to claim 1, wherein the multivalent metal salt is selected from a group consisting of: calcium chloride, poly-aluminum chloride (PAC), magnesium chloride, magnesium bromide, calcium bromide, barium chloride, calcium nitrate, magnesium sulphate, magnesium nitrate, barium nitrate, calcium acetate, magnesium acetate, barium acetate, and mixtures thereof.

6. A paper according to claim 1, wherein the pigments comprise round-like pigments,

7. A paper according to claim 1, wherein the starch is non-ionic starch.

8. A method of manufacturing a paper with a bulk of at least 1.3 cc/g and which is suitable for both inkjet and offset printing, said method comprising the steps of:
providing a base substrate having a first and a second surface and a grammage of below 100 gsm, wherein said base substrate comprises at least 50 wt % mechanical cellulosic pulp fibers and has a total filler content of below 15 wt %, all percentages calculated on a total amount of solids of said substrate,
applying a surface treatment composition on at least the first surface of said base substrate, wherein said surface treatment composition comprises pigments in a range of 15-30 wt %, starch in a range of 20-40 wt % latex in a range of 10-20 wt %, and a multivalent metal salt in a range of 10-30 wt %, all percentages calculated on a total solid contents of said surface treatment composition,
and wherein the paper has a bulk of at least 1.3 cc/g.

9. A method according to claim 8, wherein the surface treatment composition is applied onto the base substrate by use of a film coating application.

10. The method of claim 8, wherein said surface treatment composition comprises starch in a range of 30-40 wt %.

11. The method of claim 8, wherein the surface treatment composition is applied on the first surface of the substrate in an amount of less than 2 gsm.

12. The method of claim 11, wherein the surface treatment composition is applied on the second surface in an amount of less than 2 gsm.

13. The method of claim 8, wherein the multivalent metal salt is selected from a group consisting of: calcium chloride, poly-aluminum chloride (PAC), magnesium chloride, magnesium bromide, calcium bromide, barium chloride, calcium nitrate, magnesium sulphate, magnesium nitrate, barium nitrate, calcium acetate, magnesium acetate, barium acetate, and mixtures thereof.

14. The method of claim 8, wherein the pigments comprise round-like pigments.

15. The method of claim 14, wherein the pigments comprise calcium carbonate, titanium dioxide, or both.

16. The method of claim 8, wherein the starch is non-ionic starch.

17. The paper of claim 1, wherein said surface treatment composition comprises starch in a range of 30-40 wt %.

18. The paper of claim 6, wherein the pigments comprise round-like pigments.
